(19) United States
(12) Patent Application Publication
(10) Pub. No.: US 2011/0269068 A1
(43) Pub. Date: Nov. 3, 2011

(54) METHOD OF PREPARING TONER HAVING NARROW PARTICLE SIZE DISTRIBUTION

(75) Inventors: Kyoung Suk Cho, Daejeon-city (KR); Jae Bum Park, Daejeon-city (KR); Jin Young Kim, Daejeon-city (KR); Jae Kwang Hwang, Daejeon-city (KR); Sung Yul Kim, Cheongju-si (KR); Moo Eon Park, Seoul (KR); Young Jae Kwon, Daejeon-city (KR)

(73) Assignee: SAMSUNG FINE CHEMICALS CO., LTD., Ulsan-city (KR)

(21) Appl. No.: 13/143,082

(22) PCT Filed: Dec. 24, 2009
(86) PCT No.: PCT/KR2009/007760

§ 371 Date: Jun. 30, 2011

(30) Foreign Application Priority Data
Dec. 31, 2008 (KR) 10-2008-0138407

(51) Int. Cl. G03G 9/08

(52) U.S. Cl. 430/137.14

(57) ABSTRACT

According to preparing toner by emulsion aggregation, viscosity of dispersions is controlled during an initial reaction by using a cellulose derivative and/or a cyclodextrin derivative so that a particle diameter distribution of the toner is narrowed and environmental problems caused by the use of the toner may be reduced.

### CROSS-REFERENCE TO RELATED PATENT APPLICATION

This application claims the benefit of Korean Patent Application No. 10-2008-0138407, filed on Dec. 31, 2008, in the Korean Intellectual Property Office, the disclosure of which is incorporated herein in its entirety by reference.

### BACKGROUND OF THE INVENTION

1. Field of the Invention

The present invention relates to a method of preparing a toner by emulsion aggregation, and more particularly, to a method of preparing an environmentally friendly toner having a narrow particle size distribution.

2. Description of the Related Art

In general, toner is prepared by adding a colorant, a charge controller, or a releasing agent to a thermoplastic resin acting as a binding resin. In addition, an outer additive such as an inorganic metal fine powder may be added to the toner in order to provide fluidity to the toner or improve physical properties of the toner, such as charge controlling or cleaning properties wherein the inorganic metal fine powder may be silica or titanium oxide. Toner may be prepared using a physical method such as a pulverization method, or a chemical method such as a suspension and polymerization method or an emulsion aggregation method.

According to an emulsion aggregation method (refer to U.S. Pat. Nos. 5,916,725 and 6,268,103), a fine emulsion resin particle composition is prepared by emulsion polymerization and is then aggregated with, for example, a pigment in a dispersion. The emulsion aggregation method may improve problems of the pulverization method, for example, high costs and a wide particle size distribution. In addition, by using the emulsion aggregation method under controlled aggregation conditions non-spherical toner particles may be obtained.

The quality of an emulsion aggregation toner depends on raw materials used, that is, stability of a latex dispersion, a colorant dispersion, and a wax dispersion. The respective dispersions may be unstable when they are mixed during an initial reaction, and a phase separation may occur according to a time, temperature, or shear force during when the dispersions are mixed. When the mixed solution including the dispersions is unstable, the resultant toner may have a larger particle size, a wider particle size distribution, a higher sedimentation rate, and a wider molecular weight distribution. Such a toner has poor image fixability and an image formed using the toner has low quality, and thus is not preferred by consumers. Also, such a toner has a wide particle size distribution and thus production of the toner that can be used as a final product is reduced in the manufacturing process and the manufacturing yield is reduced.

Meanwhile, as people spend more time indoors or in an enclosed space such as an office, the importance of indoor environments is greater. Indoor air pollution is more serious than atmospheric pollution. This is because the atmosphere cleanses itself from atmospheric pollution, and is likely to be automatically purified along with climate changes. The atmospheric pollution is suppressed by increasing social awareness about atmospheric pollution and enforcing various regulations, but as for indoor air pollution, with or without artificial equipments for continuously circulating air, people may be directly exposed to various pollutants when in an enclosed space for long periods of time. Thus, pollution in indoors such as underground facilities, offices, or hospitals has become a serious social issue, and there are efforts to set up an indoor environmental standard.

In addition, recent technical developments have led to cheaper laser printers and thus, more laser printers are being used in underground facilities, offices, or hospitals. Conventional emulsion aggregation toners use a synthesized polymer as a latex resin. Thus, when an image is developed using a laser printer, various volatile organic compounds (VOCs) are derived from the synthesized polymer due to high-temperature heating. Such VOCs make the indoor air pollution more serious.

### SUMMARY OF THE INVENTION

The present invention provides a method of preparing a toner by emulsion aggregation. According to the method, the generation of volatile organic compound (VOCs) is hindered and the stability of dispersions used to prepare the toner is increased and thus, an environmentally friendly toner having a narrow particle size distribution is obtained.

According to an aspect of the present invention, there is provided a method of preparing toner, wherein the method includes: mixing a latex dispersion, a colorant dispersion, a wax dispersion, and an aqueous solution of at least one type of material selected from the group consisting of a cellulose derivative and a cyclodextrin derivative; adding an aggregating agent to the mixture to aggregate the mixture, thereby forming toner particles; and fusing the formed toner particles.

The cellulose derivative may be a compound represented by Formula I below:

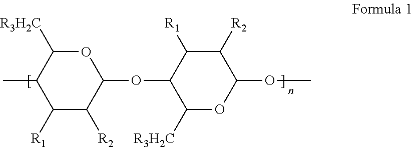

where R₁, R₂, and R₃ are each independently a hydroxyl group, a C1-C10 substituted or unsubstituted alkyl group, a C2-C10 substituted or unsubstituted acyl group, or a C6-C10 substituted or unsubstituted aryl group, wherein R₁, R₂, and R₃ are not all hydroxyl groups at the same time; and

n is an integer from 2 to 2,000,000.

The cellulose derivative may be any one selected from the group consisting of acetyl cellulose, carboxymethylcellulose, hydroxyethyl cellulose, (hydroxypropyl)methyl cellulose, (hydroxyethyl)methyl cellulose, and benzyl cellulose.

The cyclodextrin derivative may be α-cyclodextrin, β-cyclodextrin, or γ-cyclodextrin.

The total amount of the cellulose derivative and the cyclodextrin derivative may be in the range of 0.5 to 10 weight % based on the entire reaction mixture.

The latex dispersion comprises a latex resin and the total amount of the cellulose derivative and the cyclodextrin derivative may be in the range of 0.5 to 10 parts by weight based on 100 parts by weight of the latex resin in the latex dispersion.

The toner may have a core-shell structure.

### DETAILED DESCRIPTION OF THE INVENTION

Hereinafter, exemplary embodiments of the present invention will be described in detail.

A method of preparing toner includes mixing a latex dispersion, a colorant dispersion, a wax dispersion, and an aqueous solution of at least one type of material selected from the group consisting of a cellulose derivative and a cyclodextrin derivative; adding an aggregating agent to the mixture to aggregate the mixture, thereby forming toner particles; and fusing the formed toner particles.

The use of at least one type of material selected from the group consisting of a cellulose derivative and a cyclodextrin derivative as a reactant increases stability of the latex dispersion, the colorant dispersion, and the wax dispersion during the mixing and thus reduces a particle size distribution of the resultant toner particles. In addition, the amount of total volatile organic compounds (TVOC) may be reduced when the toner is prepared.

The cellulose derivative may be manufactured by esterifing, etherfing, oxidizing, halogenating, or grafting at least one group selected from a primary hydroxyl group and a secondary hydroxyl group of a cellulose compound.

The cellulose derivative may include a compound represented by Formula I below:

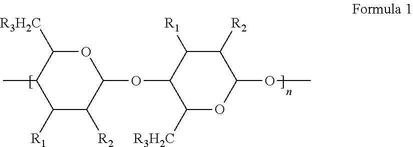

where R₁, R₂, and R₃ are each independently a hydroxyl group, a C1-C10 substituted or unsubstituted alkyl group, a C2-C10 substituted or unsubstituted acyl group, or a C6-C10 substituted or unsubstituted aryl group, wherein R₁, R₂, and R₃ are not all a hydroxyl group at the same time; and

n is an integer from 2 to 2,000,000.

For example, the cellulose derivative may be any one selected from the group consisting of acetyl cellulose, carboxymethylcellulose, hydroxyethyl cellulose, (hydroxypropyl)methyl cellulose, (hydroxyethyl)methyl cellulose, and benzyl cellulose.

The cyclodextrin derivative may be α-cyclodextrin, β-cyclodextrin, or γ-cyclodextrin.

The use of the cellulose derivative or the cyclodextrin derivative increases viscosity of reactants during mixing and stabilizes the mixture including the dispersions. Thus, toner particles having a narrow particle size distribution are obtained. In addition, the cellulose derivative and the cyclodextrin derivative adsorb volatile organic compounds (VOCs) and thus reduce the amount of TVOC, thereby reducing indoor air pollution.

Since the reaction mixture includes the aqueous solution of at least one type of material selected from a cellulose derivative and a cyclodextrin derivative, the viscosity of the entire reaction mixture is maintained to be in the range of 80 to 200 cPs (at a temperature of 25° C.).

The total amount of the cellulose derivative and the cyclodextrin derivative used may be in the range of 0.005 to 1 weight % based on the total toner reactants. If the total amount of the cellulose derivative and the cyclodextrin derivative used is less than 0.005 weight % based on the total toner reactants, the increase of stability of the latex dispersion, the colorant dispersion, and the wax dispersion is negligible. On the other hand, if the total amount of the cellulose derivative and the cyclodextrin derivative used is greater than 1 weight % based on the total toner reactants, the dispersion mixture may gelate. In addition, the total amount of the cellulose derivative and the cyclodextrin derivative used may be in the range of 0.5 to 10 parts by weight based on 100 parts by weight of a latex resin in the latex dispersion. If the total amount of the cellulose derivative and the cyclodextrin derivative used is less than 0.5 parts by weight based on 100 parts by weight of a latex resin in the latex dispersion, desired effects may not be obtained. On the other hand, if the total amount of the cellulose derivative and the cyclodextrin derivative used is greater than 10 parts by weight based on 100 parts by weight of a latex resin in the latex dispersion, fixing characteristics of the toner may be damaged.

In order to increase solubility of the cellulose derivative or cyclodextrin derivative, if necessary, an acidic or basic material and a surfactant may be added to the cellulose derivative or cyclodextrin derivative aqueous solution.

In the method of preparing a toner, according to the present embodiment of the present invention, the aggregating agent is added to a mixture including the latex dispersion, the colorant dispersion, the wax dispersion, and the aqueous solution of at least one type of material selected from the group consisting of a cellulose derivative and a cyclodextrin derivative, and then the resultant mixture is homogenized and aggregated together, thereby preparing toner particles. That is, the latex dispersion, the colorant dispersion, the wax dispersion and the aqueous solution of at least one type of material selected from the group consisting of a cellulose derivative and a cyclodextrin derivative are loaded into a reactor and then the aggregating agent is added thereto. The resultant mixture is homogenized for 10 to 100 minutes at a pH of 1.5 to 2.3, at a temperature of 20 to 30° C., and at a stirring linear velocity of 1.0 to 2.0 m/s. Then, the temperature of the reactor is increased to be in the range of 48 to 53° C. and then, aggregation is performed by stirring at a stirring linear velocity of 1.5 to 2.5 m/s.

The aggregated toner particles are frozen to stop growth of toner particles and then the frozen toner particles are fused, cooled and dried, thereby obtaining desired toner particles. The dried toner particles are treated with outer additives such as silica in order to control the amount of charges, thereby obtaining a final toner for laser printers.

The method according to the present embodiment may also be applied to a toner having a core-shell structure. When a toner having a core-shell structure is prepared, an aggregating agent is added to a mixture including a latex dispersion for a core, a colorant dispersion, a wax dispersion, and an aqueous solution of at least one type of material selected from the group consisting of a cellulose derivative and a cyclodextrin derivative and then the resultant mixture is homogenized and aggregated, thereby preparing a primary aggregated toner. Then, a latex dispersion for a shell is added to the obtained primary aggregated toner to form a shell layer. Then, the resultant toner is fused.

The latex dispersion used in the method according to the present embodiment may include a binding resin. The binding resin may be prepared by polymerizing at least one type of a polymerizable monomer selected from the group consisting of a vinyl monomer, a polar monomer having a carboxyl group, a monomer having an unsaturated polyester group, and a monomer having an aliphatic group.

The polymerization described above may be performed using, in general, a polymerization initiator, and the polymerization initiator may be a benzoyl peroxide-based initiator or an azo-based polymerization initiator.

A macromonomer and a chain transfer agent may be further used to control a number average molecular weight and a glass transition temperature (Tg) of the binding resin, respectively. Examples of the macromonomer include polyethyleneglycol ethylether methacrylate, polyethyleneglycol methyl methacrylate, and polyethyleneglycol methyl acrylate. Examples of the chain transfer agent include divinyl benzene and 1-dodecanthiol.

The amount of the macromonomer may be in the range of 0.3 to 30 parts by weight based on 100 parts by weight of the binding resin.

Some of the binding resins described above may be further reacted with a cross-linker, and the cross-linker may be an isocyanate compound and an epoxy compound.

The binding resin is cross-linked to the cross-linker, thereby producing a cross-linked resin. The amount of the cross-linked resin included in the toner may be in the range of 5 to 30 parts by weight based on 100 parts by weight of the binding resin. If the amount of the cross-linked resin is less than 5 parts by weight, a molecular weight of the cross-linked resin is reduced and a fixing temperature range is narrowed. On the other hand, if the amount of the cross-linked resin is greater than 30 parts by weight, the cross-linked resin is too rigid and thus the toner is not suitable in terms of low-temperature fixing characteristics.

The colorant dispersion may include a colorant. The colorant may be a pigment itself, or may be used in the form of a pigment master batch obtained by dispersing a pigment in a resin.

The pigment may be selected from the group consisting of a black pigment, a cyan pigment, a magenta pigment, a yellow pigment, which are commercially used, and a mixture thereof.

The amount of the colorant may be such an amount where toner is colored and a visible image is formed by development. For example, the amount of the colorant may be in the range of 1 to 20 parts by weight based on 100 parts by weight of the binding resin.

Meanwhile, an additive used to prepare toner may be a charge controller or the like.

The charge controller may be a negative charge control agent or a positive charge control agent. The negative charge control agent may be any commercially known negative charge control agent. Examples of the negative charge control agent include an organometalic complex or chelate compound; a metal-containing salicylic acid compound; and organometalic complexes of aromatic hydroxycarboxylic acid and aromatic dicarboxylic acid. In addition, the positive charge control agent may include at least one type of material selected from the group consisting of a product reformed with nigrosine and an aliphatic metal salt of nigrosine, and an onium salt such as a quaternary ammonium salt. The charge controller stably and quickly charges toner with an electrostatic force and thus stably supports toner on a development roller.

The amount of the charge controller included in the toner may be in the range of 0.1 parts by weight to 10 parts by weight based on 100 parts by weight of an entire toner composition.

A wax improves fixability of a toner image, and may be a polyalkylene wax such as a low molecular weight polypropylene or a low molecular weight polyethylene, an ester wax, a carnauba wax, or a paraffin wax. The amount of the wax included in the toner may be in the range of 0.1 parts by weight to 30 parts by weight based on 100 parts by weight of the entire toner composition. If the amount of the wax is less than 0.1 parts by weight, oil-less fixation, that is, fixation without oil, may not be obtained. On the other hand, if the amount of the wax is greater than 30 parts by weight, toner may lump during preservation.

The additive may further include an outer additive. The outer additive is used to improve fluidity of toner or to control charge characteristics of toner. Examples of the outer additive include large particle-sized silica, small particle-sized silica, and a polymer bead.

The present invention will be described in further detail with reference to the following examples. These examples are for illustrative purposes only and are not intended to limit the scope of the present invention.

### Example 1

### Preparation of Latex Dispersion

A reactor having a volume of 3 liters including a stirrer, a thermometer, and a condenser was installed in an oil vessel acting as a thermal transfer medium. 660 g of distilled water and 3.2 g of surfactant (Dowfax 2A1) were added to the reactor, the temperature of the reactor was increased to a temperature of 70° C., and stirring was performed thereon at a rate of 100 rpm. Then, 13.5 g of potassium persulfate was added thereto as a polymerization initiator. Then, an emulsion mixture including 838 g of styrene, 322 g of butyl acrylate, 37 g of 2-carboxyethyl acrylate, 22.6 g of 1,10-decandiol diacrylate acting as monomers, 507.5 g of distilled water, 22.6 g of surfactant (Dowfax 2A1), 53 g of polyethyleneglycol ethylether methacrylate acting as a macromonomer, and 18.8 g of 1-dodecanthiol acting as a chain transfer agent was stirred with a disc-type impeller at a rate of 400 to 500 rpm for 30 minutes and then the mixture was slowly loaded into the reactor for 1 hour. Then, the reaction was performed for about 8 hours and then stopped by slowly dropping the temperature to room temperature.

After the reaction was completed, a differential scanning calorimeter (DSC) was used to measure a glass transition temperature (Tg) of a binding resin. The Tg of the binding resin was 60° C. A number average molecular weight of the binding resin was measured by gel permeation chromatography (GPC) using polystyrene as a reference sample. The measured number average molecular weight of the binding resin was 70,000.

(Preparation of Colorant Dispersion)

540 g of cyan pigment (ECB303, a Dainichiseika Color & Chemical Mfg. Co., Ltd product), 27 g of surfactant (Dowfax 2A1), and 2,450 g of distilled water were loaded into a reactor having a volume of 3 liters including a stirrer, a thermometer, and a condenser, and then the mixture was preliminary dispersed by slowly stirring for about 10 hours. Then, dispersing was performed thereon four times using Ultimaizer (produced by Amstek Co., Ltd) with a 1500 bar until the particle size was 200 nm or lower. As a result, a cyan pigment dispersion was obtained.

After the dispersion was completed, the particle diameter of the obtained cyan pigment particle was measured with Multisizer 2000 (product of Malvern Co., Ltd). The obtained D50(v) was 170 nm. In this regard, D50(v) refers to a particle diameter corresponding to 50% based on a volume average particle diameter, that is, a particle diameter corresponding to 50% of the total volume when particle diameters are measured and the volume of particles is accumulated from smaller particles.

(Preparation of Wax Dispersion)

65 g of surfactant (Dowfax 2A1) and 1,935 g of distilled water were loaded into a reactor having a volume of 5 liters including a stirrer, a thermometer, and a condenser, and then 1,000 g of wax (Japanese NOF Co., Ltd., WE-5) was loaded into the reactor while slowly stirring the mixture at high temperature for about two hours. The resultant mixture was dispersed with a homogenizer (IKA Co., Ltd., T-45) for 30 minutes, thereby obtaining a wax dispersion.

After the wax dispersion was completed, the particle diameter of dispersed particles was measured with Multisizer 2000 (product of Malvern Co., Ltd.). The obtained D50(v) was 320 nm.

(Preparation of Cellulose Derivative Aqueous Solution)

1,500 g of distilled water was loaded into a reactor having a volume of 2 liters including a stirrer, a thermometer, and a condenser and then the temperature was decreased to a temperature of 10° C. Then, 20 g of hydroxypropyl methylcellulose (Anycoat-C, SAMSUNG FINE CHEMICAL Co., Ltd) was added thereto and then slowly stirred, thereby preparing a cellulose derivative aqueous solution. A viscosity of the obtained cellulose derivative aqueous solution was in the range of 300 cPs to 400 cPs. The viscosity was measured three times using a Brookfield viscometer LV set No. 3 spindle at a spindle rotational speed of 200 rpm.

(Preparation of Cyclodextrin Derivative Aqueous Solution)

1,500 g of distilled water was loaded into a reactor having a volume of 2 liters including a stirrer, a thermometer, and a condenser and then the temperature was decreased to a temperature of 20° C. Then, 20 g of β-cyclodextrin (Corn Product) was added thereto and slowly stirred, thereby obtaining a cyclodextrin derivative aqueous solution. The viscosity of the cyclodextrin derivative aqueous solution was in the range of 100 cPs to 150 cPs. The viscosity was measured three times using a Brookfield viscometer LV set No. 3 spindle at a spindle rotational speed of 200 rpm.

(Preparation of Toner Particles)

1,500 g of the prepared cellulose derivative aqueous solution was loaded into a reactor having a volume of 20 liters, and then 4,300 g of the prepared latex dispersion, 490 g of the prepared colorant dispersion, and 550 g of the prepared wax dispersion were added thereto. Then, distilled water was added thereto in such an amount that the total volume of the mixture was 14,000 g. The mixture was stirred at a rate of 120 rpm at room temperature. As an aggregating agent, 1,000 g of a mixture including 0.3N HNO₃ and poly silicato iron (PSI) in a mass ratio of 2:1 was added thereto. The temperature of the reactor was increased to a temperature of 57° C. and then, aggregation was performed by stirring at a rate of 140 rpm. The aggregation process was continuously performed until the D50 reached the range of 6.45 to 6.50 μn and then, 1,000 g of 1N sodium hydroxide aqueous solution was loaded into the reactor and stirring was performed at a rate of 120 rpm until a pH of the mixture was 4 and at a rate of 100 rpm until a pH of the mixture was 7. Then, the temperature of the reactor was increased to 96° C. while the stirring speed was reduced to 80 rpm, thereby fusing toner particles. The fusing was continuously performed until a circularity of 0.970 was obtained.

Then, the temperature of the reactor was cooled to 40° C. and toner was isolated using a filtering device (name: a filter press), and the isolated toner was washed once with 1N HNO₃ aqueous solution and five times with distilled water to remove, for example, the surfactant. Then, the washed toner particles were dried at a temperature of 40° C. for five hours in a fluidized bed dryer, thereby obtaining dried toner particles.

### Example 2

4,300 g of the prepared latex dispersion, 490 g of the prepared colorant dispersion, and 550 g of the prepared wax dispersion were added to a reactor having a volume of 20 liters, and then distilled water was added thereto in such an amount that the total amount of the mixture was 13,250 g. The mixture was stirred for 10 minutes and then toner particles were obtained in the same manner as in Example 1, except that the amount of the cellulose derivative aqueous solution used was 750 g. As an aggregating agent, 1,000 g of a mixture including 0.3N HNO₃ and poly silicato iron (PSI) in a mass ratio of 2:1 was added thereto.

### Example 3

Toner particles were obtained in the same manner as in Example 1, except that the prepared cyclodextrin derivative aqueous solution was used instead of the cellulose derivative aqueous solution.

### Comparative Example 1

Toner particles were obtained in the same manner as in Example 1, except that 4,500 g of the prepared latex dispersion, 490 g of the prepared colorant dispersion, and 550 g of the prepared wax dispersion were used and then distilled water was added thereto in such an amount that the total volume of the mixture was 14,000 g.

Evaluation Method

Properties of the toner particles prepared according to Examples 1-3 and Comparative Example 1 were measured as follows.

(1) Initial Viscosity

Initial viscosity was measured using a Brookfield viscometer LV set No. 3 spindle. The initial viscosity was measured as follows. All the dispersions and the cellulose aqueous solution were loaded into a reactor and then an aggregating agent was added thereto. The mixture was homogenized for 10 minutes to 100 minutes at a temperature of 25° C. to 30° C. and then, some of the mixture was sampled. The temperature of the sample was adjusted to be 25° C. and then a viscosity value of the sample when the spindle was rotated at a rate of 200 rpm for one minute was measured.

(2) TVOC (Amount of Total Volatile Organic Compounds)

The amount of TVOC generated from each of the toners prepared according to Examples 1-3 and Comparative Example 1 was measured using Agilent 6890N GC-MS and Gerstel TDS 3 in the following manner.

First, 10 mg of toner was placed in a desorption tube. The desorption tube was placed in a thermal desorption system (TDS) and heated at a temperature of 300° C. Gas generated from the heated toner was sent to a cryo injection system (CIS) so that the gas was condensed. Then, the condensed gas was injected into gas chromatography. In a graph obtained by gas chromatography, areas of all the peaks between hexane and hexadecane were calculated and then the obtained results were substituted in a quantitative curve of toluene to obtain the TVOC. The results are shown in Table 1 below.

(3) Particle Diameter Distribution

GSDp and GSDv of the toner particles prepared according to Examples 1-3 and Comparative Example 1 were obtained by measuring average particle diameters with a Multisizer™ 3 Coulter Counter® produced by Beckman Coulter Inc. and using Equations 1 and 2 below. The aperture of the Multisizer™ 3 Coulter Counter® was 100 μm. An appropriate amount of a surfactant was added to 50 to 100 ml of ISOTON-II (Beckman Coulter Co., Ltd) acting as an electrolyte, and then 10 to 15 mg of an evaluation sample was added thereto and then the mixture was dispersed by an ultrasonic disperser for 5 minutes, thereby preparing a sample. The results are shown in Table 1 below.

TABLE 1
[Equation 1]
$GSDp = \sqrt{\frac{D 84 p}{D 16 p}} ( p \text{:} number of particles )$
[Equation 2]
$GSDv = \sqrt{\frac{D 84 v}{D 16 v}} ( v \text{:} volume )$

| | Example 1 | Example 2 | Example 3 | Comparative |
|---|---|---|---|---|
| Initial viscosity | 260.7 | 97.5 | 95.3 | 40.2 |
| (cps) | | | | |
| TVOC | 60% | 72% | 43% | 100% |
| GSDp | 1.25 to 1.27 | 1.24 to 1.27 | 1.25 to 1.27 | 1.28 to 1.35 |
| GSDv | 1.20 to 1.23 | 1.20 to 1.23 | 1.21 to 1.24 | 1.24 to 1.30 |

As shown in Table 1, it can be seen that the dispersion mixtures used in Examples 1-3 during an initial reaction have higher viscosity than the dispersion mixture used in Comparative Example 1 during an initial reaction. Thus, it shows that the dispersions of Examples 1-3 have high stability. In addition, it can be seen that the amount of TVOC of the toners prepared according to Examples 1-3 was lower than that of the toner prepared according to Comparative Example 1 by 30% to 60%. Furthermore, it can be seen that the toners prepared according to Examples 1-3 have a narrower particle diameter distribution than the toner prepared according to Comparative Example 1.

(4) Circularity

Circularity was measured with FPIA-3000 (product of Sysmex Co., LTd, a Japanese company.) In order to prepare an evaluation sample, an appropriate amount of a surfactant was added to 50 to 100 ml of distilled water and then, 10 to 20 mg of toner particles were added thereto and dispersed for one minute in an ultrasonic disperser.

Circularity was automatically calculated according to the following Equation 3 in FPIA-3000.

Circularity=2×(area×π)^{1/2}/perimeter [Equation 3]

where the area refers to an area of a projected toner, and the perimeter refers to a circumference of the projected toner. Circularity may be in the range of 0 to 1 and as the circularity is near 1, the shape of toner is more similar to a circle.

(5) Chargeability

Chargeability was measured with Vertex Charge Analyzer 150 (Vertex Image Products, located in Pennsylvania Yukon), which is a blow-off powder chargeability evaluator.

According to a blow-off method, a mixture including powder and a carrier is placed in a cylindrical container having ends covered with a net and then a high-pressure gas is provided through one of the ends, thereby separating the powder from the carrier, that is, only the powder was blown off through pores of the net. In this regard, the amount of charge remaining in the carrier is equivalent to the amount of charge that is carried by the powder to the outside and has an opposite polarity to that of the charge that is carried by the powder to the outside. In addition, the entire electric flux of the remaining charge gathers in a condenser by a Faraday cage and the condenser is charged with electricity corresponding to the electric flux. The charge (Q) of the powder is measured by measuring electric potentials at ends of the condenser according to the following equation:

Q=CV [Equation 4]

Where C is a capacitance of the condenser, V is a voltage at ends of the condenser, and Q is a charge of the powder.

A charging rate was measured by dividing the amount of charge occurring between the carrier and the toner particle while mixing by a time taken to mix. An initial charging rate refers to a rate at which toner was charged. In the present specification, the initial charging rate was measured based on the amount of charge measured one minute after the carrier was mixed with toner.

(6) Aggregation

Aggregation was measured using a micron powder characteristics tester (product of HOSOKAWA Co.). Aggregation was measured after toner samples were left to sit under an N/N condition and a H/H condition, and higher aggregation values means worse fluidity.

N/N condition: 2 hr, 25° C., humidity 55%

H/H condition: 15 hr, 50° C., humidity 80%+2 hr, 25° C., humidity 55%

(7) Cleaning Property

A cleaning property was evaluated as follows. Toner on a photoreceptor that had been passed through a cleaning process was transferred to a white paper using a Scotch tape (3M), and a Macbath reflection density RD514 type of the transferred toner was measured. If the difference of the Macbath reflection density RD514 type from when the white paper was not contaminated was 0.01 or less, the cleaning property was evaluated as being good, and if the difference was higher than 0.01, the cleaning property was evaluated as being bad.

(8) Glossiness

Glossiness was evaluated using a BYK GARDNER micro TR1 gloss device at an angle of 20 degrees. The evaluation method was performed according to ASTM D 523/D 2457. If the evaluation value is 20 or lower, glossiness was evaluated as being high.

TABLE 2

| | | | | | Comparative |
|---|---|---|---|---|---|
| | | Example1 | Example2 | Example3 | Example1 |
| Physical | Chargeability | −20 to −25 | −18 to −30 | −19 to −32 | −12 to −15 |
| properties | (uC/g) | | | | |
| | Circularity | 0.970 | 0.971 | 0.971 | 0.970 |
| Image | Glossiness | high | high | high | high |
| performance | | | | | |
| | Cleaning property | good | good | good | good |

As shown in Table 2, it can be seen that chargeability, circularity, and cleaning properties of the toners of Examples 1-3 were similar to or higher than those of the toner of Comparative Example 1.

TABLE 3

| | | | | | Comparative |
|---|---|---|---|---|---|
| | | Example 1 | Example 2 | Example 3 | Example 1 |
| Aggregation | N/N | 81.4 | 84.5 | 82.3 | 79.3 |
| | H/H | 87.6 | 92.4 | 93.6 | 88.3 |

As shown in Table 3, fluidity of the toners of Examples 1-3 was similar to or slightly lower than that of toner of Comparative Example 1.

Toner prepared in methods of preparing toner, according to embodiments of the present invention, has a narrow particle diameter distribution. In addition, the amount of VOCs generated during the preparation process is low. Thus, the prepared toner is environmentally friendly.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of preparing toner, the method comprising:
mixing a latex dispersion, a colorant dispersion, a wax dispersion, and an aqueous solution of at least one type of material selected from the group consisting of a cellulose derivative and a cyclodextrin derivative;
adding an aggregating agent to the mixture to aggregate the mixture, thereby forming toner particles; and
fusing the formed toner particles.

2. The method of claim 1, wherein the cellulose derivative is a compound represented by Formula I below: 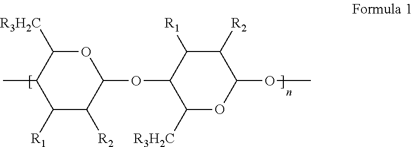
where R₁, R₂, and R₃ are each independently a hydroxyl group, a C1-C10 substituted or unsubstituted alkyl group, a C2-C10 substituted or unsubstituted acyl group, or a C6-C10 substituted or unsubstituted aryl group, wherein R₁, R₂, and R₃ are not all hydroxyl groups at the same time; and
n is an integer from 2 to 2,000,000.

3. The method of claim 2, wherein the cellulose derivative is any one selected from the group consisting of acetyl cellulose, carboxymethylcellulose, hydroxyethyl cellulose, (hydroxypropyl)methyl cellulose, (hydroxyethyl)methyl cellulose, and benzyl cellulose.

4. The method of claim 1, wherein the cyclodextrin derivative is α-cyclodextrin, β-cyclodextrin, or γ-cyclodextrin.

5. The method of claim 1, wherein the total amount of the cellulose derivative and the cyclodextrin derivative is in the range of 0.5 to 10 weight % based on the entire reaction mixture.

6. The method of claim 1, wherein the latex dispersion comprises a latex resin and the total amount of the cellulose derivative and the cyclodextrin derivative is in the range of 0.5 to 10 parts by weight based on 100 parts by weight of the latex resin in the latex dispersion.

7. The method of claim 1, wherein the latex dispersion comprises a latex resin and the latex resin comprises a styrene residue.

8. The method of claim 1, wherein the toner has a core-shell structure.
